(19) United States
(12) Patent Application Publication
(10) Pub. No.: US 2025/0011986 A1
(43) Pub. Date: Jan. 9, 2025

(54) A METHOD FOR PRODUCING A CELLULOSE PRODUCT AND A CELLULOSE PRODUCT

(71) Applicant: PULPAC AB, Västra Frölunda (SE)

(72) Inventors: Olle Högblom, Göteborg (SE); Niklas Olov Westerberg, Mölndal (SE)

(21) Appl. No.: 18/712,213

(22) PCT Filed: Nov. 18, 2022
(86) PCT No.: PCT/EP2022/082391

§ 371 Date: May 21, 2024

(30) Foreign Application Priority Data
Nov. 23, 2021 (SE) 2151423-7

(51) Int. Cl. D04H 1/492; D04H 1/425; D06C 7/02; D06H 7/00

(52) U.S. Cl. CPC D04H 1/492; D04H 1/425; D06C 7/02; D06H 7/00; D10B 2201/00; D10B 2401/02; D10B 2503/00

(57) ABSTRACT

A method for producing a cellulose product from an air-formed cellulose blank structure, wherein the method comprises the steps; providing a cellulose based material to a first mill, providing a barrier chemistry composition to the cellulose based material before the first mill; milling the cellulose based material and the barrier chemistry additive; providing an air-formed cellulose blank structure, wherein the cellulose blank structure is air-formed from cellulose fibres.

### TECHNICAL FIELD

The present disclosure relates to a method for producing a cellulose blank structure comprising a barrier chemistry composition in a method for producing a cellulose product with a barrier structure from the air-formed cellulose blank structure, where the cellulose blank structure is air-formed from cellulose fibres. The disclosure further relates to a cellulose product produced according to the method.

### BACKGROUND

Cellulose fibres are often used as raw material for producing or manufacturing products. Products formed of cellulose fibres can be used in many different situations where there is a need for having sustainable products. A wide range of products can be produced from cellulose fibres and a few examples are disposable plates and cups, blank structures and packaging materials.

Forming moulds are commonly used when manufacturing cellulose products from raw materials including cellulose fibres, and traditionally the cellulose products have been produced with wet-forming technologies. A material commonly used for cellulose fibre products is wet moulded pulp. Wet moulded pulp has the advantage of being considered as a sustainable packaging material, since it is produced from biomaterials and can be recycled after use. Consequently, wet moulded pulp has been quickly increasing in popularity for different applications. Wet moulded pulp articles are generally formed by immersing a suction forming mould into a liquid or semi liquid pulp suspension or slurry comprising cellulose fibres, and when suction is applied, a body of pulp is formed with the shape of the desired product by fibre deposition onto the forming mould. With all wet-forming technologies, there is a need for drying of the wet moulded product, where the drying is a time and energy consuming part of the production. The demands on aesthetical, chemical and mechanical properties of cellulose products are increasing, and due to the properties of wet-formed cellulose products, the mechanical strength, flexibility, and chemical properties are limited. It is also difficult in wet-forming processes to control the mechanical properties of the cellulose products with high precision.

One development in the field of producing cellulose products is the forming of cellulose fibres without using wet-forming technologies, and instead the cellulose products are produced in a dry-forming process. In the dry-forming process, an air-formed cellulose blank structure is used. The air-formed cellulose blank structure is inserted into a forming mould and during the forming of the cellulose products the cellulose blank structure is subjected to a high forming pressure and a high forming temperature.

When using cellulose products made according to the dry-forming process, the cellulose products may be exposed to liquids, food or other substances that may affect the stiffness and rigidity of the cellulose products due to the tendency of the formed cellulose products to absorb for example water, moisture, or other substances. Plastic films that are laminated to the cellulose products may be used for preventing liquid from affecting the cellulose products. However, with the demand for more environmentally friendly products there is a desire to produce the cellulose products without plastic materials.

There is thus a need for an improved method for producing cellulose products from an air-formed cellulose blank structure, where the cellulose products can be produced to resist contact with liquids, food and other substances for longer time periods without affecting the mechanical properties of the cellulose products. There is further a demand for certain types of products to hold liquids or food, where no harmful substances are added to the cellulose products.

### SUMMARY

An object of the present disclosure is to provide a method for producing a cellulose blank structure comprising a barrier chemistry composition, hereinafter called BCC, in a method for producing a cellulose product where the previously mentioned problems are avoided. This object is at least partly achieved by the features of the independent claims. The dependent claims contain further developments of the method for producing a cellulose product and the cellulose product.

The disclosure concerns a method for forming an air-formed cellulose blank structure for producing a cellulose product, wherein the method comprises the steps;
providing a flow of cellulose based material to a first mill,
providing a flow of barrier chemistry composition, hereinafter called BCC, to the cellulose based material before the first mill and/or in the first mill and/or in a forming hood 4a,
defibrating the cellulose based material in the first mill into cellulose fibres, or defibrating the cellulose based material and the BCC in the first mill into cellulose fibres,
providing an air-formed cellulose blank structure partly comprising cellulose fibres with attached BCC,
wherein the cellulose blank structure is air-formed from the cellulose fibres, wherein the method comprises the step of controlling an amount of BCC to not exceed a predetermined maximum value in the product by controlling a ratio between the cellulose based material and the BCC before the first mill and/or in the forming hood.

One advantage with providing BCC before and/or in the first mill and/or in the forming hood is that a predetermined amount BCC will be part of the cellulose blank structure which will provide for a barrier effect in the final product. By providing BCC before the first mill and/or in the first mill and/or in the forming hood gives the effect of scattering the BCC in the cellulose blank structure which allows for forming of hydrogen bonds when forming the product between the fibres that are not interfered by the BCC. Forming of the product by use of pressure, heat and an adequate water content will be explained further below. The BCC has the advantage of providing the barrier, especially after curing, but with a trade-off regarding less hydrogen bonds between the fibres, which gives less strength. Hence, it is important not to cover all fibres with BCC, but to rather scatter or distribute the BCC within the cellulose blank structure. Mixing the BCC with cellulose-based material according to the above has proven in experiment to give a suitable trade-off between barrier features and strength in the product.

The process of forming the product is advantageously done by arranging the cellulose blank structure with the BCC in a forming mould, and
heating the cellulose blank structure with the BCC to a forming temperature in the range of 100° C. to 300° C., and forming the cellulose product from the cellulose blank structure with the BCC in the forming mould, by pressing the heated cellulose blank structure with the BCC with a forming pressure of at least 1 MPa, preferably 4-20 MPa, and
cutting out the cellulose product in and/or after the forming mould from the cellulose blank structure forming a residual cellulose fibre structure of the remaining cellulose blank structure.

Advantages with these features are that when forming the cellulose products, the BCC forms a barrier structure that is preventing water from being absorbed in the cellulose fibre structure of the cellulose products. When exposing the cellulose products to liquids, food or other substances the formed barrier is preventing the substances from affecting the stiffness and rigidity of the cellulose products. The formed cellulose products are thus prevented from absorbing water, moisture or other substances. With the method, plastic materials can be avoided. The cellulose products can be produced to resist contact with liquids, food and other substances for longer periods without affecting the mechanical properties of the cellulose products. Further, no harmful substances are added to the cellulose products with the method.

According to one example, the residual cellulose fibre structure can go to waste, or according to another example, the residual cellulose fibre structure can be recycled by feeding the material of the residual cellulose fibre structure to the first mill and/or to the forming hood as a complement to the cellulose-based material.

One advantage with the method is that the residual cellulose fibre structure comprises BCC and when mixed in the first mill and/or in the forming hood with the cellulose based material the BCC becomes embedded in the air-formed cellulose blank structure and gives a good barrier structure within the cellulose blank structure and therefore also in the end product.

According to one example embodiment, the method comprises the step of adjusting the amount of BCC dependent on a material ratio based on an amount of the residual cellulose fibre structure and an amount of the cellulose-based material fed to the first mill and/or in the forming hood.

One advantage here is that the method provides for suitable adjustments when starting up the system such that the amount of BCC can be controlled such that a suitable value is reached when the system has reached steady state, i.e. when the material ratio has stabilized. For example, when starting up the process there is possibly no material, i.e. the residual cellulose fibre structure, to be returned to the first mill until the machine has produced and fed enough air-formed cellulose blank structure to allow for a material to be fed back to the first mill and/or the forming hood. When fed back to the first mill and/or the forming hood, the residual cellulose fibre structure comprises BCC and dependent on where and how BCC has been provided to the cellulose blank structure, adjustments may be needed in order to reach a predetermined maximum value of BCC in the end product. If not regulated, the amount of BCC could either accumulate to too high values or may be diluted to a too low level. Examples will follow below. Furthermore, when starting up the process and before the feeding back of residual cellulose fibre structure, then the step of providing the cellulose based material to the first mill can be allowed at a first rate, but when the residual cellulose fibre structure reaches the first mill and/or the forming hood then the amount of cellulose based material needs to be controlled in order to control the total amount of fibres to be provided to the air-formed cellulose blank structure in the air-forming step. If not controlled and regulated, also here an unwanted increase of material, i.e. e.g. material thickness, in the cellulose blank structure can be the result.

According to one example embodiment, the step of adjusting the amount of the BCC is dynamically adjusted until the material ratio has reached a steady state during the production of the cellulose product. As mentioned above, the recycled residual cellulose fibre structure comprises BCC and dependent on where the BCC source is positioned in the manufacturing process the amount of BCC in the process can be varied during the transient period from start to steady state. Here, dynamically adjusted can in some examples mean that a BCC in spray form is controlled and/or that the ratio between the recycled residual cellulose fibre structure and the cellulose-based material is controlled by e.g. controlling the speed, i.e. feeding rate, of the cellulose based material compared to the recycled residual cellulose fibre structure.

According to one example embodiment, the step of adjusting the amount of BCC is dynamically adjusted to ensure that an amount of BCC in the product is kept below the predetermined maximum value.

One advantage with the dynamic possibility is that the predetermined value can be set dependent to regulatory and legal restrictions for different jurisdictions and for different type of products. For example, a food grade product, i.e. a product intended to carry food products, may have a different maximum value BCC compared to a product not intended for the food market.

According to one example embodiment, the step of feeding the material of residual cellulose fibre structure to the first mill and/or to the forming hood comprises the step of milling the residual cellulose fibre structure in a second mill before feeding the material of the residual cellulose fibre structure to the first mill and/or to the forming hood. Here, the first mill can be configured with a bypass conduit that passes the working part of the first mill, i.e. that part that defibrates the cellulose based material in the first mill such that the recycled and already milled residual cellulose fibre structure is blended/mixed with the cellulose-based material milled in the first mill. The blending/mixing takes place at least partly in the first mill and further in the forming box. As an alternative, the recycled and already milled residual cellulose fibre structure can be fed via a bypass conduit to the forming hood wherein the recycled and already milled residual cellulose fibre structure is blended/mixed with the milled cellulose based material in the forming hood.

One advantage here is that the milled residual cellulose fibre structure from the second mill is in the form of defibrated fibres that can be transported from the second mill to the first mill via an air conduit where the air is a carrying medium for the milled fibres. Another advantage is that the amount of residual cellulose fibre structure can be easily monitored by use of suitable flux sensors which are known per se in prior art.

According one example embodiment, the step of feeding the material of residual cellulose fibre structure to the first mill comprises feeding the residual cellulose fibre structure directly to the first mill, i.e. without further defibration, or via a second calendaring apparatus.

One advantage here is that only one mill, i.e. the first mill, can be used for the entire operation thereby reducing cost and maintenance. One advantage with using the second calendaring apparatus is that the recycled residual fibre structure can be hard compacted, which has shown to give a good defibration. It should be noted that the first calendaring apparatus is not intended to calendar the cellulose blank structure 2 harder than to give an improved transporting ability of the cellulose blank structure 2.

According to one example embodiment, the step of providing BCC comprises the step of providing a first tissue layer onto one side of the cellulose blank structure, wherein the first tissue layer comprises BCC. The tissue is pre-prepared with BCC at a predetermined amount from the tissue manufacturer and/or the tissue is treated by spray BCC in the process line before or after having been provided to the cellulose blank structure. If the tissue is pre-prepared, the amount of BCC in the end product is regulated by the above-described material ratio in the first mill and/or in the forming hood.

One advantage with pre-prepared tissue, is that the pre-prepared tissue has a controlled and specific amount of BCC that makes it easy to calculate the amount of BCC in the end product by the controlling the material ratio in the first mill and/or in the forming hood. Another advantage is that a pre-prepared tissue removes the need for a BCC spray unit and thus removes cost and the need for maintenance of the spray box.

One advantage with spray BCC is that the amount of BCC in the end product can be controlled by just regulating the amount of spray BCC in the process.

One advantage with the combination of pre-prepared tissue and spray BCC is that the amount BCC during any transient period can be adjusted more easily due to the possibility of controlling the amount of BCC in the end product. Another advantage is that the spray BCC can be reduced to zero in a stable steady state, but with the possibility to control and add BCC during the manufacturing process should something happen during production of the cellulose product that affects the steady state into a new transient period, e.g. by recycling a smaller amount of residual cellulose fibre structure due a fault in the cut out process. In another example, spray BCC is present during the manufacturing process and a larger amount of recycled residual cellulose fibre structure is fed to the first mill due to e.g. less cutting out in the cut out process, and the amount of spray BCC may then be diminished.

According to one example embodiment, the step of providing BCC comprises the step of providing a second tissue layer to one side of the cellulose blank structure, wherein the second tissue layer comprises BCC.

The second tissue layer can also be pre-prepared with BCC and/or be treated by spray BCC in the manufacturing process, with similar advantages to what has been described above in connection to the first tissue above.

According to one example, the first tissue can be positioned on one side of the cellulose web structure and the second tissue can be on the opposite side of the cellulose web structure. This has the advantage that the product can be designed with one type of tissue layer on one side, e.g. an inside of a product, and another type of tissue layer on the other side, e.g. the outside, giving the product two sides with different properties. It should however be noted that the same type of tissue can be used as the first and the second tissue, giving similar properties on both sides of the product. Furthermore, the first and second tissue can be applied on the same side and if suitable, a third or more tissue can be applied on the same or the opposing side.

The use of a tissue added to the cellulose web structure has the further advantage that the BCC in the recycled residual cellulose fibre structure is mixed with the defibrated cellulose based material in the first mill giving the cellulose web structure an amount of BCC embedded in the structure, but also a tissue layer forming an outer layer of the product that can have a higher amount of BCC giving a higher degree of barrier properties than the core without exceeding the maximum amount BCC in the end product. The higher amount of BCC in the outer barrier layer gives a first barrier property that hinders a liquid from penetrating the barrier layer, but the BCC in the core of the product, i.e. in the part of the product essentially made from the cellulose web structure, gives further barrier properties also if the liquid penetrates the outer barrier that hinders disintegration of the core of the product.

It should be noted that when adding a first and/or second tissue to the cellulose web structure, then reference to feeding, forming, cutting and curing of the cellulose web structure relates to the entire composition of cellulose web structure and added tissue(s).

According to what has been discussed above, the step of providing BCC comprises the step of providing a BCC dispersion, i.e. e.g. a spray BCC, to the first and/or second tissue layer during production of the cellulose product and/or the step of providing BCC to the first and/or second tissue layer by providing BCC before production of the cellulose product.

According to one example, the step of providing BCC comprises the step of providing BCC to the cellulose based material before production of the cellulose product and/or in production of the cellulose product.

According to one example, the step of providing BCC to the cellulose based material before production of the cellulose product comprises the step of pre-treating the cellulose material partly with BCC forming a sectioned cellulose based material partly comprising BCC and/or where the step of providing BCC to the cellulose based material in production of the cellulose product comprises the step of providing BCC to selected parts of the cellulose material forming a sectioned base cellulose material partly comprising BCC.

It should be noted that pre-treatment refers to any type of addition of BCC to the cellulose based material, but it is of utmost importance that the BCC is not dispersed in the cellulose based material such that most or all of the fibres in the cellulose based material is contaminated since this would jeopardize the possibility to form hydrogen bonds when forming the product. Hence, the BCC could be added to the cellulose based material e.g. as an additional layer to the cellulose based material and/or strands of BCC in the Cellulose based material, just as long as there is a significant portion of fibres not contaminated with BCC. The first mill will defibrate all fibres and some of the fibres will have BCC attached, but at least a significant part of the fibres should be void of BCC such that a suitable blend/mix of fibres are air-formed into the cellulose blank. Should the process be arranged such that there will be no recycling of the residual cellulose fibre structure, then the amount of BCC in the cellulose based material governs the amount of BCC in the end product unless one or more tissues with BCC are added to the cellulose blank structure. In the latter case, the total amount of BCC has to be calculated in order to not exceed the predetermined maximum value of BCC in the end product. For similar reasons, any addition of BCC in the process has to be taken into consideration.

According to one example, the step of providing BCC to the cellulose based material in production of the cellulose product can be realized by adding spray BCC to the cellulose based material before the first mill and/or an extra flow of cellulose-based material comprising BCC. If the process uses two or more flows of cellulose based materials to the first mill, then at least one of the flows can be void of BCC and one or more may comprise a large amount BCC since the mix of the flows in the first mill gives an adequate mix of BCC treated fibres and fibres with no BCC attached. Should the process be arranged such that there will be no recycling of the residual cellulose fibre structure, then the amount of BCC in the cellulose based material or materials governs the amount of BCC in the end product unless one or more tissues with BCC are added to the cellulose blank structure. In the latter case, the total amount of BCC has to be calculated in order to not exceed the predetermined maximum value of BCC in the end product. For similar reasons, any addition of BCC in the process has to be taken into consideration.

According to one example, the cellulose-based material is pre-treated partly with BCC, which has the advantage of removing the need for spray BCC. The BCC in the cellulose-based material will be part of the cellulose blank structure and can be recycled with the residual cellulose fibre structure, either via a second mill or directly to the first mill according to the above. The recycled BCC in the recycled residual cellulose fibre structure together with the BCC in the cellulose-based material has to be controlled and the amount of cellulose-based material is controlled dependent on amount of recycled residual cellulose fibre structure, especially during the transient period. According to another example, the cellulosed-based material is treated with spray BCC before the first mill, which has the advantage of controlling the BCC dependent on amount of recycled residual cellulose fibre structure, at least in the transient period.

According to one example, the cellulose-based material is pre-treated with BCC and spray BCC is added to the cellulose based material. As with the tissue described above, the combination has the advantage of controlling the amount of BCC during different transient periods.

According to one example, the step of providing BCC comprises the step of providing a BCC to the cellulose blank structure after the first mill and before the forming step. In analogy with the above discussion regarding BCC in the tissue and/or BCC in the cellulose based material, spray BCC added to the cellulose blank structure has the advantage of controlling BCC in the end product during transient periods as well as during steady state when recycling the residual cellulose fibre structure.

According to one example, the method comprises the step of providing BCC to the residual cellulose fibre structure before the recycled residual cellulose fibre structure reaches the first mill and/or the forming hood. This has the advantage that the amount BCC in the first mill and/or in the forming hood can be controlled, at least during the transient periods.

It should be noted that the above-described example embodiments can be used one by one or in any type of combination. Hence, the method allows for process step including BCC in the cellulose based material and/or BCC in one or more tissues and/or BCC added to toe cellulose blank structure. To control the amount of BCC in the end product, the process has to be controlled at least in any transient period according to what has been described above.

It should further be noted that the step of providing BCC to the cellulose based material before production of the cellulose product and/or in production of the cellulose product has the advantage that recycling the residual cellulose fibre structure is not necessary since BCC is continuously added before or in the first mill. The step of providing BCC to the cellulose based material before production of the cellulose product and/or in production of the cellulose product can be combined with addition of tissue according to the above and/or the step of providing a BCC to the cellulose blank structure after the first mill and before the forming step recycling the residual cellulose fibre structure. Combining the step of providing BCC to the cellulose based material before production of the cellulose product and/or in production of the cellulose product and adding tissue with BCC has the advantage of allowing same or different amount of BCC in the end product. Should for example the tissue have more BCC than the cellulose blank structure, then the end product could have a better outer barrier, i.e. outer layer comprising of tissue and BCC, than the core of the product, i.e. the part of the product mainly formed from the cellulose blank structure, which allows for a good first outer barrier but also a barrier function in the core without exceeding a maximum amount of BCC in the end product.

However, providing BCC to the cellulose based material before production of the cellulose product and/or in production of the cellulose product and recycling the residual cellulose fibre structure has the advantage of less residual fibres that goes to waste. Combing e.g. the step of providing BCC to the cellulose based material before production of the cellulose product and/or in production of the cellulose product in a set amount BCC per weight and providing one or more tissue layers with the same amount in weight percentage as in the cellulose based material, has the advantage that recycling the residual cellulose fibre structure and mixing it with a suitable amount of cellulose based material to compensate for material loss from the cut-out product, gives the same amount BCC per weight in the first mill, which has the advantage that there will be no transient period for adjusting the BCC since the weight percentage is steady throughout all stages of the production of the cellulose product.

According to one example, the step of forming the cellulose product from the cellulose blank structure comprises the step of curing the BCC based product in the heated forming mould. One advantage here is that curing the product in the forming mould eliminates or at least reduces the need for additional curing after the forming mould. The forming mould can be brought to a suitable period and the residence time in the forming mould can be controlled to a suitable time period to allow for the water content in the product to escape from the product in the forming mould and at the same time the BCC becomes more fluent and penetrates into spaces earlier occupied by water molecules without jeopardizing the hydrogen bonds formed in the cellulose product due to water content, heat and pressure. The forming mould typically comprises two mould parts, at least one that is connected to a press apparatus providing the pressure in the forming mould when closing the forming mould. The press can be arranged such that it vibrates and/or slightly opens and closes in order to let steam escape from the forming mould. The forming mould may as an alternative or as a complement to the press movement be arranged with steam passage conduits and/or openings allowing steam to escape from the forming mould during pressing.

According to one example, the step of forming the cellulose product from the cellulose blank structure comprises the step of curing the BCC based product after the step of cutting in a suitable thermal processing device. One advantage here is that the rest water can escape from the product and the BCC can further migrate into the fibrous structure of the product.

According to an aspect of the disclosure, the forming pressure is an isostatic forming pressure of at least 1 MPa, preferably 4-20 MPa. The isostatic forming pressure efficiently forms the cellulose products when they are having complex shapes. An isostatic pressure is possible to achieve by having one mould part in a rigid form, i.e. steel, composite or the like, and the second mould part in a resilient material, e.g. silicone or the like, that during pressure takes a fluid form that applies an essential equal pressure on the cellulose material in the mould during pressure. However, both the two mould parts could as well be made from rigid materials and the shape of the mould parts adapted such that the pressure on the cellulose material in the mould is subject to an essentially even pressure.

With regard to the above description, cellulose based material refers to any type of cellulose based material from the forest and/or agricultural production. It can be provided in the form of a roll of continuous sheet and/or a bale and/or pellets like, etc.

With regard to the above description, spray BCC refers to BCC in a dispersion that is sprayable, i.e. possible to administer as small droplets via a nozzle or the like. Spray BCC could as an alternative be administered as a dry or semi-dry powder by any suitable apparatus, e.g. a nozzle with a gas, e.g. air, as a carrying medium. When BCC is applied as a dry powder, the air-formed cellulose blank structure will partly comprise cellulose fibres with BCC in a dry form.

According to an aspect of the disclosure, the BCC dispersion is in a wet state in the cellulose blank structure. When the BCC dispersion is in the wet state the forming of the cellulose products in the forming mould forming the barrier preventing water from being absorbed in the formed cellulose products.

According to another aspect of the disclosure, the BCC dispersion is at least partly in a wet state in the cellulose blank structure prior to and/or during the heating and forming in the forming mould. In the forming mould, the water from the dispersion is evaporating and the BCC is establishing an outer barrier structure on the formed cellulose products that efficiently is preventing water from being absorbed into the cellulose fibres of the cellulose products.

According to another aspect of the disclosure, the BCC dispersion in the application step is applied on a first surface and/or a second surface of the cellulose blank structure. It is with the method thus possible to apply the dispersions on both sides of the cellulose blank structure or alternatively on one side of the cellulose blank structure, depending on the type of cellulose products produced. A further advantage with BCC in a water dispersion is that water is added to the cellulose fibres, which is necessary for forming hydrogen bonds and thus a hard product.

The amount of BCC relative the amount of cellulose fibres in the end product determines the mixing of BCC into the cellulose blank structure and/or mixing of residual cellulose fibre structure and cellulose-based material fed to the first mill and/or in the forming hood. This can be expressed in several ways, such as a maximum weight percentage, volume percentage etc., depending on if residual cellulose fibre structure is used or not. The end product should have a predetermined maximum value of BCC.

If residual cellulose fibre structure is used, the material ratio determines the amount of BCC in the end product. If no residual cellulose fibre structure is used, the amount of BCC added before the first mill and/or in the forming hood, and/or the amount of BCC added after the first mill and the forming hood by the addition of tissue with BCC or spray BCC on the cellulose blank structure, determines the amount of BCC in the end product.

With reference to the above description, tissue refers to a cellulose-based material in a thin sheet form. The tissue can be compacted in any suitable form with any suitable GSM, grams per square meter, dependent on product.

Furthermore, the cellulose blank structure can be formed in with any suitable GSM dependent on product.

Yet furthermore, the cellulose blank structure is controlled to comprise a selected amount of water that allows for forming of hydrogen bonds during forming of the product in the forming mould. Water can be added e.g. via a BCC dispersion and/or by adding water to the cellulose based material before and/or in production of the cellulose product.

When recycling the residual cellulose fibre structure to the first mill and/or the forming hood, the amount of BCC in the first mill and/or in the forming hood, can be controlled by controlling the flow rate of the cellulose-based material and/or the flow rate of the residual cellulose fibre structure. The flow rate of the residual cellulose fibre structure is essentially constant due to the speed of air-forming and forming steps, but the flow rate of the residual cellulose fibre structure could be controlled if the residual cellulose fibre structure comprises more BCC than anticipated, for example if the cutting step is faulty. Then, a buffer unit can be used in order to slow down the flow of residual cellulose fibre structure to the first mill, such that the flow of cellulose based material can be controlled to ensure both the correct mix BCC in the first mill and/or the forming hood, but also make sure that a predetermined amount of fibres are air-formed cellulose blank.

The invention further relates to a cellulose product manufactured with a method according to any one of the above-described examples, wherein the product comprises BCC embedded in a core of the product.

Hence, according to one example, the product comprises a surface layer on at least a first side comprising formed tissue with an amount BCC exceeding the amount BCC in the core which has the advantage that the surface layer has a high degree of barrier properties, and in addition to that the core has further barrier properties that hinders disintegration of the core should the surface layer allow a small amount of liquid to pass through the surface layer.

The above-described process is especially advantageous when forming a non-flat product since the method does not require a pre-shaping process step before the forming step, due to that the cellulose blank structure allows for being formed from the essentially flat state into the non-essentially flat state by the closing motion of the mould parts.

Furthermore, suitable sensors can be provided to one, many or all of the machine parts for monitoring the machine parts and/or suitable sensors can be provided to one, many or all of the material lines for monitoring e.g. speed, flux, quality, thickness, water content, and BCC content. The sensors are connected, wireless and/or by wire, to a control unit that receives signals from the sensors and computes driving parameters from the signals that can be used to control driving units of the machine parts. Hence, the control unit is connected wireless and/or by wire to selected driving units.

According to one embodiment, and with reference to the above, the barrier chemistry composition, BCC, refers to alkyl ketene dimer, AKD. Experiments have shown that AKD is a suitable barrier chemistry composition for the above-mentioned examples and example embodiments. AKD gives the product suitable barrier properties and the mixing of AKD into the cellulose blank structure has the advantage of giving a core with suitable barrier properties, but at the same time allows for hydrogen bonds for a strong product.

According to another embodiment, and with reference to the above, the barrier chemistry composition, BCC, refers to sucrose ester or resin, or alkyl ketene dimer, AKD, combined with resin. These barrier compositions also shows good result when mixing with cellulose fibres free from BCC.

According to another embodiment, and with reference to the above, the barrier chemistry composition, BCC, refers to a biodegradable polymer.

### BRIEF DESCRIPTION OF DRAWINGS

The disclosure will be described in detail in the following, with reference to the attached drawings, in which

FIG. 1 schematically shows, a production line for producing cellulose products according to the disclosure,

FIG. 2 schematically shows, a production line for producing cellulose products according to another embodiment of the disclosure,

FIG. 3 schematically shows, a production line for producing cellulose products according to another embodiment of the disclosure,

FIG. 4. schematically shows, a production line for producing cellulose products according to another embodiment of the disclosure,

FIG. 5 schematically shows, a production line for producing cellulose products according to another embodiment of the disclosure,

FIG. 6 schematically shows, a production line for producing cellulose products according to another embodiment of the disclosure,

FIG. 7 schematically shows, a production line for producing cellulose products according to another embodiment of the disclosure,

FIG. 8 schematically shows, a production line for producing cellulose products according to another embodiment of the disclosure,

FIG. 9 schematically shows, a cross-sectional side view of a cellulose product manufactured with a process according to any one of FIGS. 1-8, and in which,

FIG. 10 schematically shows a flow chart of the method for producing a cellulose blank structure.

### DESCRIPTION OF EXAMPLE EMBODIMENTS

Various aspects of the disclosure will hereinafter be described in conjunction with the appended drawings to illustrate and not to limit the disclosure, wherein like designations denote like elements, and variations of the described aspects are not restricted to the specifically shown embodiments, but are applicable on other variations of the disclosure.

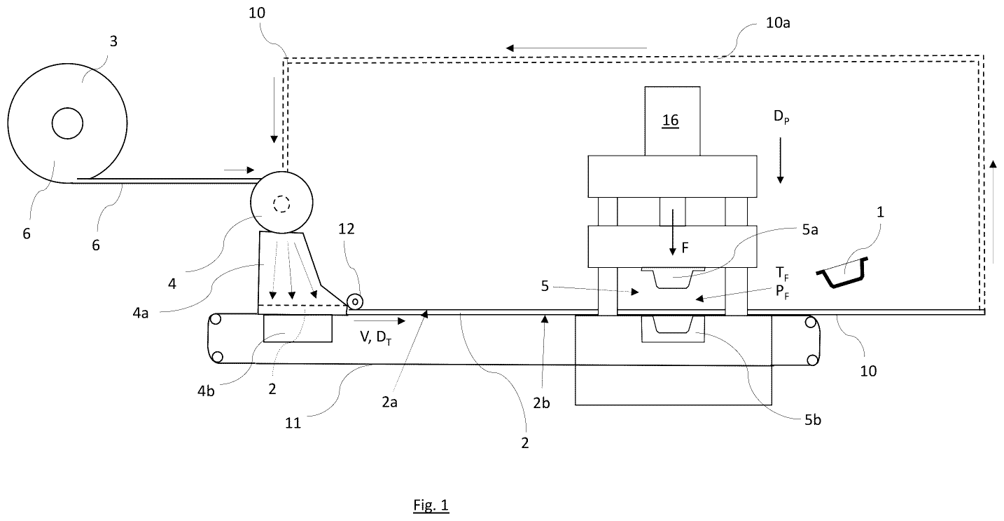

FIG. 1 schematically illustrates a production line for producing a cellulose product 1 from an air-formed cellulose blank structure 2, where the cellulose blank structure 2 is air-formed from cellulose fibres. With a cellulose blank structure 2 is meant a fibre web structure produced from cellulose fibres. With air-forming of the cellulose blank structure 2 is meant the formation of a cellulose blank structure 2 in a dry-forming process in which cellulose fibres are air-formed to produce the cellulose blank structure 2. When forming the cellulose blank structure 2 in the air-forming process, the cellulose fibres are carried and formed to the fibre blank structure by air as carrying medium. This is different from a normal papermaking process or a traditional wet-forming process, where water is used as carrying medium for the cellulose fibres when forming the paper or fibre structure. In the air-forming process, small amounts of water or other substances may if desired be added to the cellulose fibres in order to change the properties of the cellulose product, but air is still used as carrying medium in the forming process. The cellulose blank structure 2 may have a dryness that is mainly corresponding to the ambient humidity in the atmosphere surrounding the dry-formed cellulose blank structure 2.

FIGS. 1-8 schematically shows that the air-forming comprises providing a cellulose based material to a first mill 4 that mechanically defibrates the material to cellulose fibres. The fibres are then applied to an endless conveyer belt 11 via a forming hood 4a that guides the air stream comprising the fibres from the first mill 4 to the conveyer belt 11. The conveyer belt 11 is arranged with through openings that allows air to pass though the conveyor belt from that side of the conveyer belt where the fibres are applied, a first side, to an opposite second side. On the second side, a suction box 4b is arranged in connection to the conveyer belt 11 that is connected to a fan that creates an under-pressure generating a negative pressure gradient between the first side and the second side of the conveyer belt via the openings in the conveyer belt. The negative pressure gradient allows for the fibres to be drawn to the first side of the conveyer belt and then to stabilize the fibres in position on the conveyer belt. The negative pressure gradient further has the advantage that areas on the first side not yet covered with fibres will be subject to a larger negative pressure gradient than the covered sections allowing for further fibres to be directed to such areas in order to generate an even distribution of fibres on the first side. Here, negative pressure gradient refers to that the pressure on the first side is greater than the pressure on the second side. The through openings are designed and arranged in size and numbers dependent on e.g. of fibres and predicted structure of the air-formed blank structure on the first side. The air-formed blank structure can typically be calendared somewhat via a suitable first calendaring apparatus 12 in order to allow for easier transport of the air-formed blank structure from the forming hood to the forming mould 5. The conveyer belt 11 can also be referred to a forming belt or forming wire. It should be noted that this type of arrangement for forming the air-formed blank structure is known per se in e.g. WO2017160218.

The cellulose blank structure 2 may be formed of cellulose fibres in a conventional dry-forming process and be configured in different ways. For example, the cellulose blank structure 2 may have a composition where the fibres are of the same origin or alternatively contain a mix of two or more types of cellulose fibres, depending on the desired properties of the cellulose products 1. The cellulose fibres used in the cellulose blank structure 2 are during the forming of the cellulose products 1 strongly bonded to each other with hydrogen bonds. The cellulose fibres may be mixed with other substances or compounds to a certain amount if desired. With cellulose fibres is meant any type of cellulose fibres, such as natural cellulose fibres or manufactured cellulose fibres.

The cellulose blank structure 2 may have a single-layer or a multi-layer structure. A cellulose blank structure 2 having a single-layer structure is referring to a cellulose blank structure that is formed of one layer containing cellulose fibres. A cellulose blank structure 2 having a multi-layer structure is referring to a cellulose blank structure that is formed of two or more layers containing cellulose fibres, where the layers may have the same or different compositions or configurations.

According to the disclosure, the method comprises the step; providing the air-formed cellulose blank structure 2, where the cellulose blank structure 2 is air-formed from cellulose fibres. The air-forming of the cellulose blank structure 2 may take place as a separate process or method step, in which the cellulose blank structure 2 may be pre-formed and stacked in sheets or arranged in rolls as a rolled web, before the forming of the cellulose products 1. In the embodiments illustrated in FIGS. 1-8, the air-forming of the cellulose blank structure 2 is part of a continuous process where the cellulose blanks structure 2 is transported for further forming into the cellulose products directly after the air-forming step.

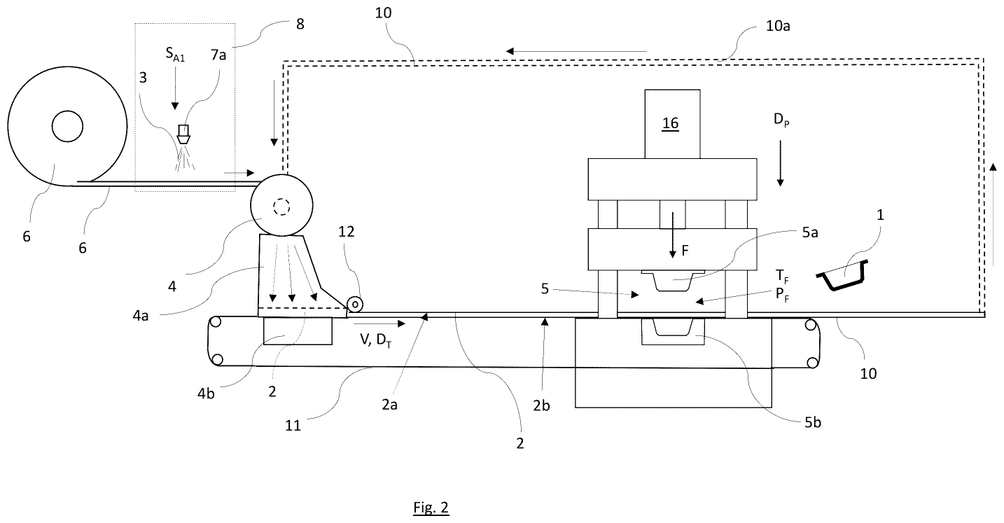

In the method illustrated in FIGS. 1-8, the cellulose blank structure 2 is transported to a forming mould 5 for forming of the cellulose products 1 from the cellulose blank structure 2. The forming mould 5 is part of a forming mould system, where the forming mould 5 in the illustrated embodiments comprises a first mould part 5a, a second mould part 5b, and a forming cavity. The forming cavity is formed between the first mould part 5a and the second mould part 5b during a forming operation in which the cellulose blank structure 2 is formed into the cellulose products 1. The cellulose blank structure 2 is transported in a transportation direction D_{T} with a suitable transportation speed V, as indicated in FIGS. 1 and 2. The forming mould 5 may be of any suitable design and construction.

In order to form the cellulose products 1, the cellulose blank structure 2 is arranged in the forming mould 5, where the cellulose blank structure 2 is heated to a specific forming temperature T_{F} and pressed with a specific forming pressure P_{F} between the mould parts in the forming cavity of the forming mould 5. When forming the cellulose products 1, a force F is applied to the first forming mould part 5a and/or the second forming mould part 5b, as illustrated in the figures. The applied force F is during the forming process establishing the forming pressure P_{F} in the forming cavity. According to the disclosure, when forming the cellulose products 1 from the cellulose blank structure 2 in the forming mould 5, a forming pressure P_{F} of at least 1 MPa, preferably in the range 4-20 MPa, and a forming temperature T_{F} in the range of 100° C. to 300° C. are applied to the cellulose blank structure 2. The cellulose fibres in the cellulose blank structure 2 are in the forming process bonded to each other in a way where the resulting cellulose products 1 are having good mechanical properties. The forming mould parts may suitably be made of a stiff material, such as for example steel, aluminium, or other suitable metals. The forming pressure P_{F} may be isostatic or non-isostatic depending on the types of cellulose products 1 produced or on the forming moulds 5 used.

The forming temperature T_{F} of the cellulose blank structure 2 may for example be measured with suitable temperature sensors when the cellulose blank structure 2 is formed between the mould parts, such as for example temperature sensors integrated in the mould parts, or thermochromic temperature sensors arranged in connection to or in the cellulose blank structure 2. Other suitable sensors may for example be IR sensors measuring the temperature of the cellulose blank structure 2 directly after forming between the mould parts.

Tests have shown that higher forming temperatures will give stronger bonding between the cellulose fibres when being pressed at a specific forming pressure. With forming temperatures T_{F} above 100° C. together with a forming pressure P_{F} of at least 1 MPa, the cellulose fibres will be strongly bonded to each other with hydrogen bonds. A higher forming temperature T_{F} will increase the fibril aggregation, water resistance, Young's modulus and the mechanical properties of the final cellulose product. The high pressure is important for fibril aggregation between the cellulose fibers in the cellulose products 1. At temperatures higher than 300° C., the cellulose fibres will be thermally degraded and therefore temperatures above 300° C. should be avoided. The forming pressure P_{F} and the forming temperature T_{F} may be chosen to be suitable for the specific cellulose products 1 to be produced.

The cellulose products 1 may as a non-limiting example be formed in the forming mould 5 during a forming time period in a range of 0.001 to 20 seconds. As an alternative, the forming time period may be in a range of 0.01 to 15.0 seconds or in a range of 0.1 to 10.0 seconds. The time period is chosen so that the desired properties of the cellulose products 1 are achieved. Longer forming time periods can be needed if the cellulose blank structure 2 is heated in the forming mould 5, compared to a pre-heated cellulose blank structure 2. “According to one example, the pre-heating comprises the step of adding steam to the cellulose blank structure 2 (not shown). This has the advantage of both pre-heating the cellulose blanks structure 2 and adding water for the formation of hydrogen bonds during forming.

The heating of the cellulose blank structure 2 may take place before the pressing in the forming mould 5 or at least partly before the pressing in the forming mould 5. As an alternative, the heating of the cellulose blank structure 2 may take place in the forming mould 5 when being pressed. The heating of the cellulose blank structure 2 may for example be accomplished through heating the forming mould 5. The forming pressure may also be applied before heating the cellulose blank structure 2, and for example, the heating of the cellulose blank structure 2 may take place in the forming mould 5 during pressing.

The cellulose blank structure 2 may be arranged into the forming mould 5 in any suitable way, and as an example, the cellulose blank structure 2 may be manually arranged in the forming mould 5. Another alternative is to arrange a feeding device for the cellulose blank structure 2, which is transporting the cellulose blank structure 2 to the forming mould 5 in the transportation direction D_{T} with the transportation speed V. The feeding device could for example be a conveyor belt, a forming wire unit, an industrial robot, or any other suitable manufacturing equipment. The transportation speed V may differ depending on the types of cellulose products 1 produced, and is chosen to match the forming speed in the forming mould 5.

In the illustrated embodiments, the first mould part 5a and the second mould part 5b are movably arranged in relation to each other in a pressing direction D_{P} and further arranged to be pressed in relation towards each other during forming of the cellulose products 2 with the force F. The force F may vary during the forming process and depend on the type of cellulose products 1 formed and the forming equipment used. When forming the cellulose products 1, the cellulose blank structure 2 is arranged in the forming mould 5 when the forming mould 5 is in an open state between the first mould part 5a and the second mould part 5b. The forming cavity may be arranged with a shape that is corresponding to the final shape of the cellulose products 1. The cellulose blank structure 2 may be arranged in the forming mould 5 to fully or partly cover the forming cavity. When the cellulose blank structure 2 has been arranged in the forming mould 5, the first mould part 5a and the second mould part 5b are moved in relation to and towards each other during the forming process. When a suitable forming pressure P_{F}, or a suitable distance between the mould parts is achieved, the movement of the mould parts is stopped. The mould parts are thereafter moved in a direction away from each other after a certain time period or directly after the mould parts have stopped.

The forming mould system can for example be constructed so that the first mould part 5a or the second mould part 5b is movable and arranged to move towards the other mould part during the forming process, where the other mould part is stationary or non-movably arranged. In an alternative solution, both the first mould part 5a and the second mould part 5b are movably arranged, where the first mould part 5a and the second mould part 5b are displaced in directions towards each other during the forming process. The moving mould part or alternatively moving mould parts may be displaced with a suitable actuator, such as a hydraulic, pneumatic, or electric actuator. A combination of different actuators may also be used. The relative speed between the first mould part 5a and the second mould part 5b during the forming process is chosen so that the cellulose blank structure 2 is evenly distributed in the forming cavity during the forming process. The actuator or actuators used for moving the first mould part 5a, or alternatively the second mould part 5b, or both mould parts may for example be pressure controlled, wherein the relative movement of the first mould part 5a in relation to the second mould part 5b is stopped when the correct forming pressure is established in the forming mould. The first mould part 5a and the second mould part 5b may be arranged in a suitable stand, frame, or similar structure to hold the mould parts, and an actuator arrangement may be used for moving the first mould part 5a and/or the second mould part 5b.

It should be understood that the forming mould 5 may have other designs and constructions compared to the ones described above, such as for example a rotary forming mould construction. The forming mould 5 may also for example be arranged with a cutting device, where the cellulose blank structure 2 is cut into a desired shape in the forming mould 5 during the forming process. When the cellulose products 1 have been cut from the cellulose blank structure 2 after the forming process, a remaining residual cellulose fibre structure 10 is formed from the remaining cellulose blank structure 2. The residual cellulose fibre structure 10 may be recycled and used again when air-forming new cellulose blank structures 2. The residual cellulose fibre structure 10 may be collected with a suitable collection device, such as for example a suction arrangement with transportation pipes for collecting and transporting the residual cellulose fibre structure 10 to a desired location.

The cellulose blank structure 2 may comprise one or more additives that are altering the mechanical, hydrophobic, and/or oleophobic properties of the cellulose products 1. In order to achieve the desired properties of the formed cellulose products 1, the cellulose fibres should be strongly bonded to each other through hydrogen bonds in a way so that the resulting cellulose products 1 will have good mechanical properties. The additives used may therefore not impact the bonding of the cellulose fibres during the forming process to a high extent.

One preferred property of the cellulose products 1 is the ability to hold or withstand liquids, such as for example when the cellulose products are used in contact with beverages, food, and other water-containing substances. An additive used when producing cellulose products in traditional wet-forming processes is for example alkyl ketene dimer, hereinafter called AKD.

Tests have shown that unique product properties may be achieved with AKD added to the dry-formed cellulose blank structure 2 when forming the cellulose products 1 under specific conditions and with specific process parameters. Relevant process parameters are a high forming pressure P_{F} and a high forming temperature T_{F}. When using the AKD, a high level of hydrophobicity can be achieved, resulting in cellulose products 1 with a high ability to withstand liquids, such as water, without negatively affecting the mechanical properties of the cellulose products 1.

In another embodiment, other barrier chemistry compositions than AKD are possible. Test have shown that sucrose ester or resin are suitable barrier chemistry compositions. According to one embodiment, AKD together with resin is a suitable barrier chemistry composition.

In the below examples, the invention is described as using a barrier chemistry composition, hereinafter called BCC, but with reference to the above BCC refers to AKD in one embodiment, sucrose ester in another embodiment and resin or a combination of resin and AKD in further embodiments.

FIGS. 1-8 show in various embodiments a method for forming an air-formed cellulose blank structure 2 for producing a cellulose product 1, wherein the method comprises the steps;
providing a flow of cellulose based material 6 to a first mill 4,
providing a flow of barrier chemistry composition, hereinafter called BCC, 3 to the cellulose based material 6 before the first mill 4 and/or in the first mill 4 and/or in the forming hood 4a,
defibrating the cellulose based material 6 in the first mill 4 into cellulose fibres, or defibrating the cellulose based material 6 and the BCC 3 in the first mill 4 into cellulose fibres,
providing an air-formed cellulose blank structure 2 partly comprising cellulose fibres with attached BCC 3,
wherein the cellulose blank structure 2 is air-formed from the cellulose fibres, wherein the method comprises the step of controlling an amount of BCC to not exceed a predetermined maximum value in the product 1 by controlling a ratio between the cellulose based material 6; 10 and the BCC 3 before the first mill 4 and/or in the forming hood 4a.

FIGS. 1 and 2 schematically shows an apparatus and a method where the step of providing BCC 3 comprises the step of providing BCC 3 to the cellulose based material 6 before production of the cellulose product and/or in production of the cellulose product. FIG. 1 shows that the BCC is prepared in the cellulose based material before production of the cellulose product, meaning that the BCC has been added to the cellulose based material 6 when preparing the cellulose based material in a suitable plant where wood and/or agricultural products are treated such that cellulose fibres are produced and formed into a roll, bale, pellets or the like. This process of forming cellulose based materials are known per se, however it is the utmost importance that only parts of the cellulose based material comprises BCC and that other parts are free from BCC, unless an additional flow of cellulose based material is provided to the first BCC for reasons explained in the summary. The advantage here is that BCC is part of the cellulose based material before the first mill, allowing the first mill to defibrate the cellulose based material into fibres where BCC are part of the material stream from the first mill to the air-forming process step in a suitable manner where the BCC is distributed such that enough fibres are free from BCC to allow for forming of hydrogen bonds in the forming step and at the same time give a barrier property in the final product. FIG. 2 shows that BCC 3 is added to the cellulose-based material 6 during production of the cellulose product, meaning that the BCC is added to the cellulose based material 6 when it is in the production line. This has similar advantages as the pre-prepared cellulose based material with BCC, possibly with the further advantage that the BCC 3 becomes less evenly distributed than in the pre-prepared cellulose based material with BCC which allows for even further hydrogen bonds in the forming step. As mentioned above, the BCC 3 can be provided to the cellulose-based material 6 before production of the cellulose product and in production of the cellulose product, i.e. a combination of what is shown in FIGS. 1 and 2, with similar advantages.

The step of providing BCC to the cellulose based material 6 before production of the cellulose product can comprise the step of pre-treating the cellulose material partly with BCC forming a sectioned cellulose based material partly comprising BCC 3 and/or where the step of providing BCC to the cellulose based material 6 in production of the cellulose product comprises the step of providing BCC to selected parts of the cellulose material forming a sectioned base cellulose material partly comprising BCC 3.

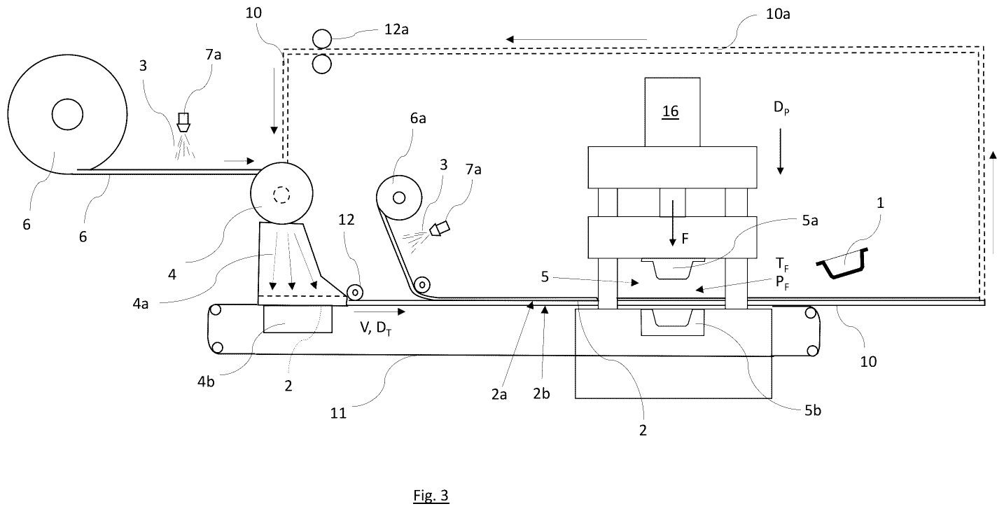

FIG. 3 schematically shows where the method comprises the step of providing a first tissue layer 6a onto one side 2a of the cellulose blank structure 2, wherein the first tissue layer comprises BCC 3. FIG. 3 shows that the step of providing BCC 3 to the cellulose based material 6 before production of the cellulose product and/or in production of the cellulose product in FIGS. 1 and 2 can be combined with the step of providing the first tissue layer 6a in FIG. 3. However, if the residual cellulose fibre structure 10 is recycled 10a as indicated with dotted lines, then BCC is fed to the first mill via the residual cellulose fibre structure 10 and thus gives the advantage of adding BCC to the cellulose based material in the first mill 4 as stated above.

FIG. 3 further shows that the recycled residual fibre structure 10 is calendared in a second calendaring apparatus 12a before returning to the first mill 4. The second calendaring apparatus is advantageously arranged to hard compact the recycled residual fibre structure 10 since a hard compacted cellulose material has shown to give good defibration in the first mill 4. It should be noted that the first calendaring apparatus is not intended to calendar the cellulose blank structure 2 harder than to give an improved transporting ability of the cellulose blank structure 2. Both the first and the second calendaring apparatus 12, 12a can be made from e.g. two opposing rolls or two opposing conveyer belts, or a combination of the two or any other suitable compacting arrangement.

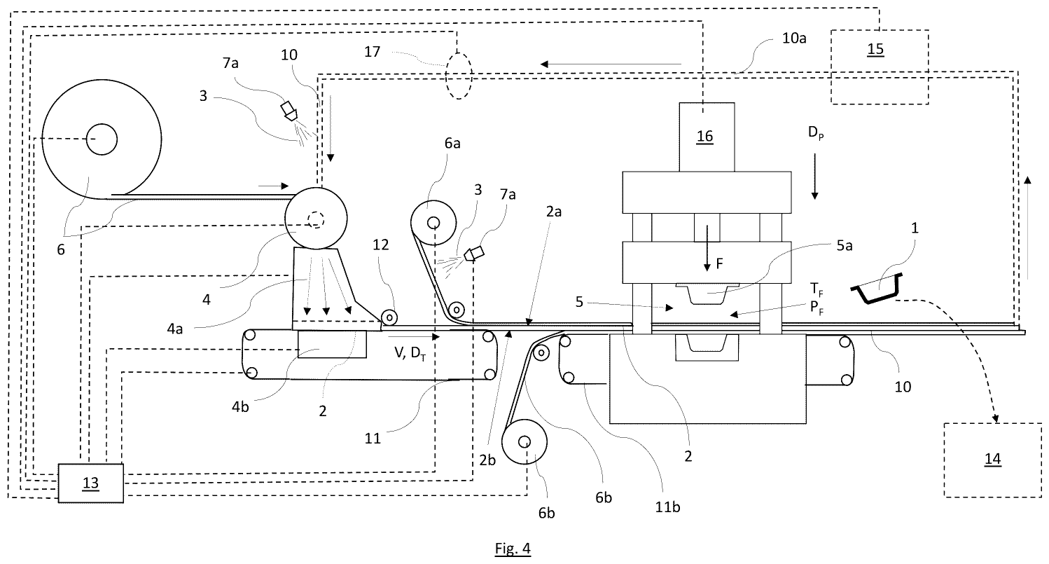

FIG. 4 schematically shows where the method comprises the step of providing a second tissue layer 6b to one side of the cellulose blank structure 2, wherein the second tissue layer comprises BCC 3 in addition to the first tissue layer 6a. The tissue layers 6a, 6b can be provided on each side of the cellulose blank structure 2 as in FIG. 3.

The step of providing a BCC to the first and/or second tissue layer 6a, 6b can be done during production of the cellulose product and/or the BCC 3 can be provided to the first and/or second tissue layer before production of the cellulose product, which is shown in FIGS. 3 and 4.

FIG. 4 also shows that the cellulose blank structure 2 and the first and second tissue layers 6a, 6b are fed to the forming mould 5 by any suitable carrying means 11b, e.g. one or more conveyors, rolls, feeding plates, or the like.

It should be noted that when adding a first and/or second tissue to the cellulose web structure, then the reference above and below to feeding, forming, cutting and curing of the cellulose web structure relates to the entire composition of cellulose web structure and added tissue.

FIG. 4 shows that the residual cellulose fibre structure 10 is recycled to the first mill 4. The amount of BCC in the first mill can be controlled by controlling the flow rate of the cellulose-based material 6 and/or the flow rate of the residual cellulose fibre structure 10. The flow rate of the residual cellulose fibre structure 10 is essentially constant due to the speed of air-forming and forming steps, but the flow rate of the residual cellulose fibre structure 10 could be controlled if the residual cellulose fibre structure 10 comprises more BCC than anticipated, for example if the cutting step is faulty. Then, a return buffer unit 15 can be used in order to slow down the flow of residual cellulose fibre structure 10 to the first mill 4, such that the flow of cellulose based material 6 can be controlled to ensure both the correct mix BCC in the first mill 4 but also make sure that a predetermined amount of fibres are air-formed cellulose blank.

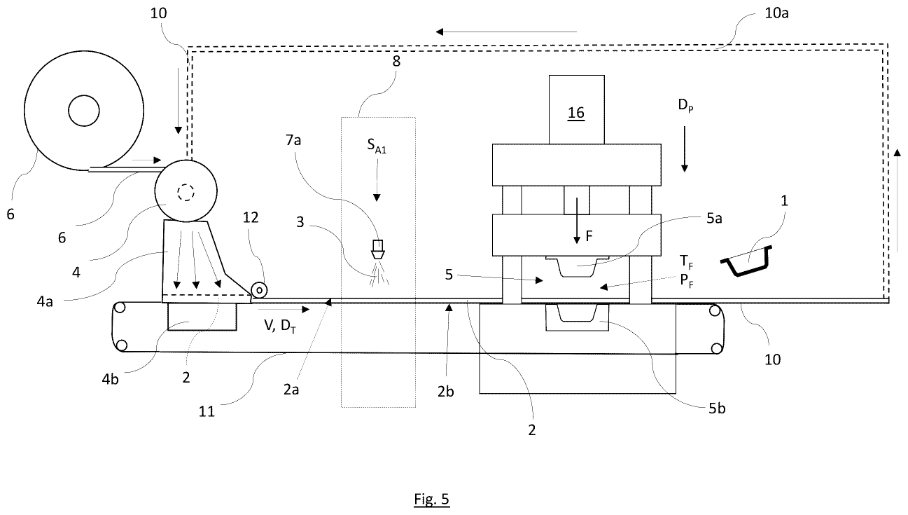

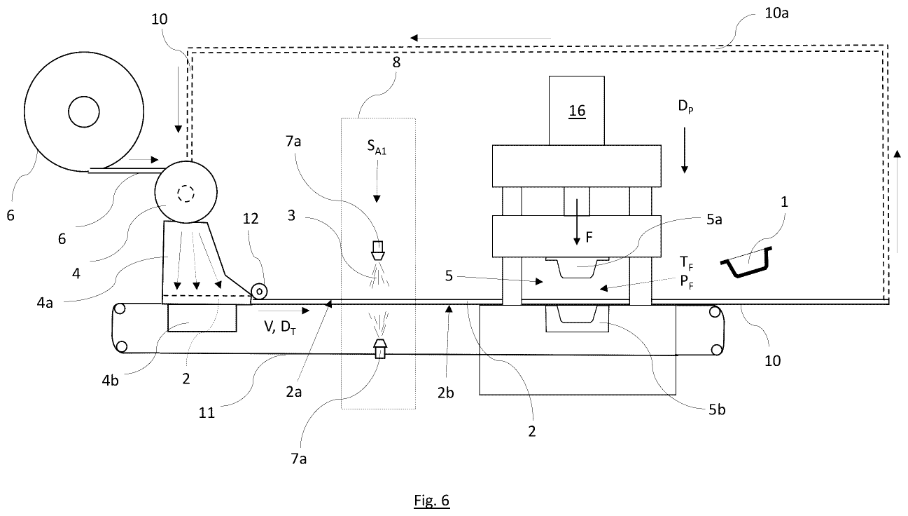

FIG. 5 schematically shows where the method comprises the step of providing BCC 3 to the cellulose blank structure 2. FIG. 6 schematically shows where the method comprises the step of providing BCC 3 to both sides of the cellulose blank structure 2. The step of adding BCC to one or both sides of the cellulose blank structure is possible as a sole step or an additional step when recycling the residual cellulose fibre structure, but is an additional step of providing BCC to a process without recycling since otherwise the first mill would not be fed both a flow of cellulose fibre material and BCC.

FIGS. 1-8 schematically show where the method comprises the step of cutting out the cellulose product 1 in and/or after the forming mould 5 from the cellulose blank structure 2 forming a residual cellulose fibre structure 10 of the remaining cellulose blank structure 2, and
feeding the material of the residual cellulose fibre structure 10 to the first mill 4 as a complement to the cellulose-based material 6.

According to one example shown in FIGS. 1-6, the step of feeding the material of residual cellulose fibre structure 10 to the first mill 4 comprises feeding the residual cellulose fibre structure 10 directly to the first mill 4. This can be done by any suitable type of transporting means, e.g. rolls, conveyer belt, etc.

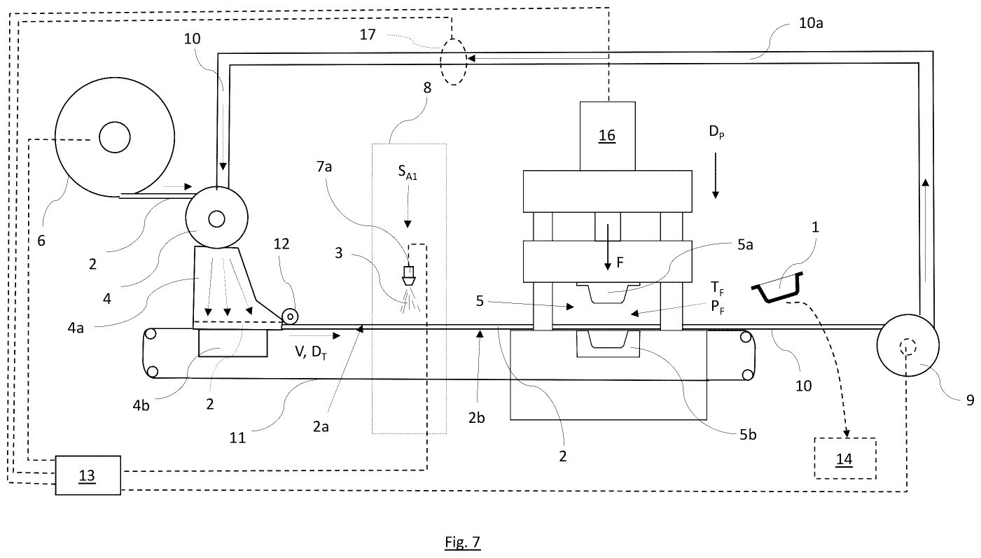

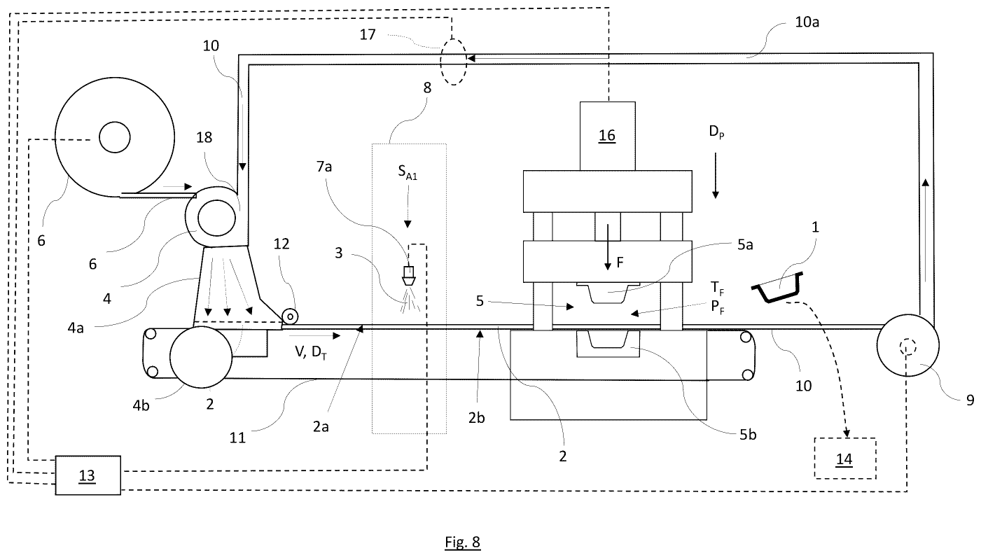

According to one example shown in FIGS. 7 and 8, the step of feeding the material of residual cellulose fibre structure 10 to the first mill 4 and/or the forming hood 4a comprises the step of milling the residual cellulose fibre structure 10 in a second mill 9 before feeding the material of the residual cellulose fibre structure 10 to the first mill 4 and/or the forming hood 4a. One advantage here is that the milled residual cellulose fibre structure 10 can be transported with air as a carrying medium in a suitable piping system.

According to one example shown in FIG. 8, the step of feeding the material of residual cellulose fibre structure 10 to the first mill 4 and/or the forming hood 4a comprises the step of milling the residual cellulose fibre structure 10 in a second mill 9 before feeding the material of the residual cellulose fibre structure 10 to the first mill 4 and/or to the forming hood 4a. The first mill 4 can be configured with a bypass conduit 18 that transports defibrated fibres from the second mill 9 to the forming hood 4a. Hence, the defibrated fibres from the second mill 9 is fed to the first mill 4, but also directly to the forming hood 4a via the bypass conduit 18. The bypass conduit has the advantage that the cellulose based material 6 defibrated in the first mill 4 is mixed in the first mill with the defibrated fibres from the second mill 9 comprising BCC, before the forming hood 4a. As an alternative, the defibrated fibres from the second mill 9 can be fed directly to the forming hood 4a via an alternative bypass conduit (not shown). One advantage here is that the milled residual cellulose fibre structure 10 can be transported with air as a carrying medium in a suitable piping system.

FIGS. 4, 7 and 8 schematically shows that method comprises the step of adjusting the BCC 3 dependent on a material ratio based on an amount of the residual cellulose fibre structure 10 and an amount of the cellulose-based material fed to the first mill 4 and/or to the forming hood as depicted in FIG. 8.

According to one example, the step of adjusting the amount of the BCC 3 is dynamically adjusted until the material ratio has reached a steady state during the production of the cellulose product.

The step of adjusting the amount of BCC 3 is dynamically adjusted to ensure that an amount of BCC in the product is kept below a predetermined maximum value.

FIGS. 4, 7 and 8 schematically show that a control unit 13 is connected to machine parts in the production line as well as to sensors 17 monitoring machine parts and/or suitable positions in the production line. This allows for the control unit to receive information from the sensors regarding e.g. speed and/or thickness and/or evenness and or amount BCC and/or moist content in the cellulose blank structure and/or amount cut away products and/or moist content in the residual cellulose fibre structure. This further allows for the control unit to calculate suitable driving parameters and allows for the control unit to send control signals to the machine parts for controlling e.g. flow speed of the cellulose based material and/or flow speed of the residual cellulose fibre structure and/or BCC and/or adding of water to the cellulose based structure and/or fan speed of the suction box. It should be noted that a similar control unit 13 can be configured in any one or a combination of the examples shown in FIGS. 1-8.

FIGS. 1-3 and 5-6 shows a method, wherein the step of forming the cellulose product 1 from the cellulose blank structure 2 comprises the step of curing the BCC based product 1 in the heated forming mould.

FIGS. 4 and 7 further shows a method, wherein the step of and forming the cellulose product 1 from the cellulose blank structure 2 comprises the step of curing the BCC based product 1 after the step of cutting in a curing unit 14 in a suitable thermal processing device. The curing of the BCC based product can be made in both the above-mentioned curing steps.

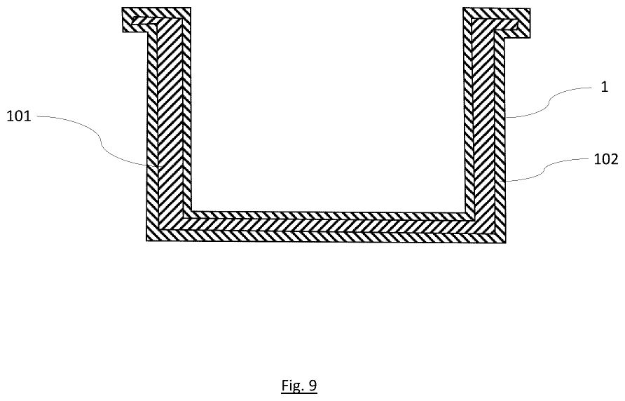

FIG. 9 schematically shows a cross-section of a cellulose product 1 manufactured with a method according to any one of the above-described example, wherein the product comprises BCC embedded in a core 101 of the product 1.

In FIG. 9, the product 1 comprises a surface layer 102 on at least a first side comprising formed tissue with an amount BCC exceeding the amount BCC in the core.

In the embodiments illustrated in FIGS. 5-8, the BCC dispersion 3 is applied to an upper first surface 2a on the first side of the cellulose blank structure 2 and in FIG. 6 an embodiment where BCC 3 is applied also to a lower second surface 2b on the second side of the cellulose blank structure 2. A set of first spray nozzles 7a may be arranged for applying the BCC dispersion 3 from above the cellulose blank structure 2 onto the first surface 2a and from below the cellulose blank structure 2 onto the second surface 2b. One or more first spray nozzles 7a may be used for applying the BCC dispersion 3 onto the first surface 2a and one or more first spray nozzles 7a may be used for applying the BCC dispersion 3 onto the second surface 2b. A set of second spray nozzles (not shown) may be used for applying further BCC from above the cellulose blank structure 2 onto the first surface 2a and from below the cellulose blank structure 2 onto the second surface 2b. One or more second spray nozzles may be used for applying the BCC onto the first surface 2a and one or more second spray nozzles 7a may be used for applying the BCC onto the second surface 2b. The spray nozzles used may be of any suitable construction for distributing the respective dispersions under hydraulic or pneumatic pressure, such as for example spray nozzles for hydraulic spraying which do not employ compressed air. The arrangement of spray nozzles may differ from the ones described and illustrated, depending on the configuration, shape, and size of the cellulose blank structure 2. Other suitable application methods and equipment may also be used instead of, or in combination with, spraying and the use of spray nozzles. Other application technologies may for example include application of the BCC dispersion 3 with a tissue 6a, 6b, see FIGs. 3 and 4 in direct contact with the first surface 2a and/or the second surface 2b of the cellulose blank structure 2; slot coating for the application of the BCC dispersion 3; and/or screen-printing for the application of the BCC dispersion 3.

The spray nozzles in the different embodiments may spray the respective dispersions continuously or intermittently onto the cellulose blank structure 2. The dispersions may also be applied over the whole cellulose blank structure or only on parts or zones of the cellulose blank structure 2. The spray nozzles may suitably be arranged in a spray booth 8, see FIGs. 1 and 5-8, or similar structure, as schematically indicated in the figures. The spray booth 8 may prevent that the respective dispersions when sprayed are spread into the surrounding environment. One or more separation walls may be arranged for separating the area where the BCC dispersion 3 is applied to the cellulose blank structure 2, as shown in the figures. The one or more separation walls may be part of the structure forming the spray booth 8 or arranged as separate wall structures. The separation walls may be made of any suitable material and are preventing that the respective dispersions are mixed during the application onto the cellulose blank structure 2 with the spray nozzles.

The cellulose blank structure 2 with the applied BCC 3 is arranged in the forming mould 5. The cellulose blank structure 2 with the applied BCC dispersion 3 is heated to a forming temperature T_{F} in the range of 100° C. to 300° C., and the cellulose product 1 is formed from the cellulose blank structure 2 with the applied BCC dispersion 3 in the forming mould 5, by pressing the heated cellulose blank structure 2 with the applied BCC dispersion 3 with a forming pressure P_{F} of at least 1 MPa, preferably 4-20 MPa. The cellulose products 1 may after forming in the forming mould 5 be cured in a curing oven 9 or other suitable thermal processing device, such as for example infrared heating lamps or an ultra violet light source, if desired. Further additives may also be applied on the formed cellulose products 1 if suitable.

To achieve the desired results, the BCC dispersion 3 is at least partly in a wet state in the cellulose blank structure 2 prior to and/or during the heating and forming in the forming mould 5. During heating and pressing the cellulose blank structure 2 in the forming mould 5, the water from the BCC dispersion is evaporating and the formation of BCC barrier is establishing an outer barrier structure on the formed cellulose products 1 that efficiently is preventing water from being absorbed into the cellulose fibres of the cellulose products 1.

The BCC is as described above forming an outer barrier structure with the tissue or the surface applied BCC in addition to the BCC in the cellulose blank structure, and the BCC structure is not interfering with the bonding between all the cellulose fibres with hydrogen bonds within the inner parts of the cellulose blank structure 2 during the forming of the cellulose products 1.

The forming mould system may further comprise at least one deformation element arranged in the forming cavity and attached to the first mould part 5a and/or the second mould part 5b, where the deformation element during forming of the cellulose products 1 is arranged to exert a forming pressure P_{F} on the cellulose blank structure 2. During the forming, the deformation element is deformed to exert a pressure on the cellulose blank structure 2 and through the deformation an even pressure distribution is achieved in the forming mould 5.

The deformation element is during forming of the cellulose products 1 arranged to exert a forming pressure P_{F} on the cellulose blank structure 2. To exert a required forming pressure P_{F} on the cellulose blank structure 2, the deformation element is made of a material that can be deformed when a force or pressure is applied. For example, the deformation element is suitably made of an elastic material capable of recovering size and shape after deformation. The deformation element is further suitably made of a material that is withstanding the high forming pressure and temperature levels used when forming the cellulose products 1 in the forming mould 5.

During the forming process, the deformation element is deformed to exert the forming pressure P_{F} on the cellulose blank structure 2. Through the deformation an even pressure distribution can be achieved in the forming mould 5, even if the cellulose products 1 are having complex three-dimensional shapes with cut-outs, apertures and holes, or if the cellulose blank structures 2 used are having varying densities, thicknesses, or grammage levels.

Certain elastic or deformable materials have fluid-like properties when being exposed to high pressure levels. If the deformation element is made of such a material, an even pressure distribution in the forming mould 5 can be achieved in the forming process, where the pressure exerted on the cellulose blank structure 2 from the deformation element is equal or essentially equal in all directions in the forming mould 5. When the deformation element during pressure is in its fluid-like state, a uniform fluid-like pressure distribution is achieved in the forming mould 5. The forming pressure is with such a material thus applied to the cellulose blank structure 2 from all directions, and the deformation element is in this way during the forming of the cellulose products 1 exerting an isostatic forming pressure P_{F} on the cellulose blank structure 2. The isostatic forming pressure P_{F} is establishing a uniform pressure in all directions in the forming mould 5 on the cellulose blank structure 2. The isostatic forming pressure P_{F} is providing an efficient forming process of the cellulose products 1 in the forming mould 5, and the cellulose products 1 can be produced with high quality even if having complex shapes. According to the disclosure, a suitable isostatic forming pressure P_{F} when forming the cellulose products 2 is at least 1 MPa, preferably in the range 4-20 MPa.

The deformation element may be made of a suitable structure of elastomeric material, where the material has the ability to establish a uniform pressure on the cellulose blank structure 2 in the forming mould 5 during the forming process. As an example, the deformation element is made of a massive structure or an essentially massive structure of silicone rubber, polyurethane, polychloroprene, or rubber with a hardness in the range 20-90 Shore A. Other materials for the deformation element may for example be suitable gel materials, liquid crystal elastomers, and MR fluids.

In the different embodiments described above, the deformation element may be releasably attached to the first mould part 5a or the second mould part 5b. The deformation element is shaped into a shape suitable for the forming mould 5, wherein the deformation element during the forming of the cellulose product 1 is enabling an efficient pressure distribution on the cellulose blank structure 2.

In an alternative embodiment, the deformation element instead comprises a flexible membrane and a pressure media. With this construction, the deformation element during the forming of the cellulose product 1 is enabling an efficient pressure distribution on the cellulose blank structure 2. The deformation element may for example be arranged in connection to the first mould part 5a and the pressure media may for example be hydraulic oil exerting a pressure on the flexible membrane during the forming of the cellulose products 1. An outer part of the flexible membrane may for example be attached to a lower surface of the first mould part 5a, wherein a sealed volume is formed between the flexible membrane, and the lower surface. The pressure media may be arranged to flow into and out from the sealed volume through a flow channel arranged in the first mould part 5a. Through the pressure media, the deformation element is exerting a forming pressure on the cellulose blank. During the forming process, the pressure media is allowed to flow into the sealed volume. In this way, the flexible membrane is exerting the forming pressure on the cellulose blank structure 2 arranged in the forming cavity of the forming mould 5 when being deformed. As described above, a suitable forming pressure P_{F} when forming the cellulose products 1 is at least 1 MPa, preferably in the range 4-20 MPa. By applying a suitable pressure on the cellulose blank structure 2 with the flexible membrane, the cellulose fibres in the cellulose blank structure 2 are compressed in the forming mould 5. The applied pressure on the cellulose blank structure 2 from the pressure media and the flexible membrane may be isostatic in order to compress the cellulose fibres evenly regardless of their relative position on the forming mould 5 and regardless of the actual local amount of fibres. The pressure media used in the forming process may be any suitable fluid, such as for example hydraulic oil, water and air.

It should be understood that both isostatic forming and non-isostatic forming may be achieved in the forming mould 5, depending on the design and construction of the forming mould 5. A deformation element may also be used for non-isostatic forming in the forming mould 5, for example when using a deformation element in combination with stiff mould parts.

The forming mould system may further comprise a heating device arranged in connection to the first mould part 5a and/or the second mould part 5b. During forming of the cellulose products 1 the first mould part 5a and/or the second mould part 5b may be heated to a forming mould temperature in the range 100-500° C. to establish the forming temperature T_{F} in the range of 100° C. to 300° C. that needs to be applied to the cellulose blank structure 2. The heating device may be integrated in the first mould part 5a and/or the second mould part 5b, and suitable heating devices 10 are e.g. an electrical heater or a fluid heater. Other suitable heat sources may also be used.

The forming mould system may further comprise a pressing unit 16 arranged to apply a pressure on the first mould part 5a and/or the second mould part 5b. The pressing unit 16 may also be used for displacing the first mould part 5a and/or the second mould part 5b. The moving mould part or alternatively moving mould parts may be displaced with a suitable pressing actuator, such as a hydraulic, pneumatic, or electric actuator.

FIGS. 4, 7 and 8 schematically show that suitable sensors 17 can be provided to one, many or all of the machine parts for monitoring the machine parts and/or suitable sensors 17 can be provided to one, many or all of the material lines for monitoring e.g. speed, flux, quality, thickness, water content, BCC content. The sensors 17 are connected, wireless and/or by wire, to the control unit 13 that receives signals from the sensors 17 and computes driving parameters from the signals that can be used to control driving units of the machine parts. Hence, the control unit 13 is connected wireless and/or by wire to selected driving units. The control unit is advantageously used to control the amount of BCC in the cellulose blank structure 2. Similar sensors and control system can be used in the examples described in FIGS. 1-8, even though not shown in all figures.

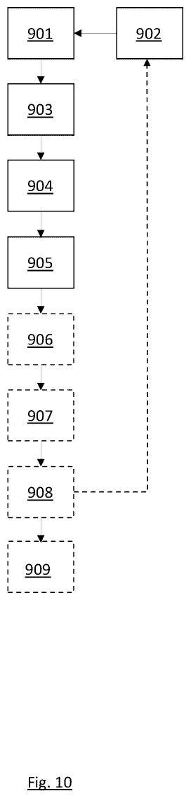

FIG. 10 schematically shows a flow chart of the method for producing a cellulose blank structure with BCC for producing a product 1 according to what has been disclosed above, where:
Box 901 refers to the step of providing a flow of cellulose based material 6 to a first mill 4,
Box 902 refers to the step providing a flow of BCC 3 to the cellulose based material 6 before the first mill 4 and/or in the first mill 4 and/or to the forming hood 4a,
Box 903 refers to the step of controlling an amount of BCC to not exceed a predetermined maximum value in the product by controlling a ratio between the cellulose based material and the BCC before the first mill 4 and/or in the first mill 4 and/or in the forming hood 4a.
Box 904 refers to the step of defibrating the cellulose based material 6 in the first mill 4 into cellulose fibres, or defibrating the cellulose based material 6 and the BCC 3 in the first mill 4 into cellulose fibres
Box 905 refers to the step of providing an air-formed cellulose blank structure 2 partly comprising fibres with attached BCC 3, wherein the cellulose blank structure 2 is air-formed from the cellulose fibres, wherein the method comprises
Box 906-909 refers to additional steps when forming the cellulose based product 1, where
Box 906 refers to the step of providing additional BCC to the cellulose blank structure, e.g. via spray BCC and/or one or more tissue layers comprising BCC,
Box 907 refers to the step of forming the product 1 in a forming mould and according to one example also curing the product,
Box 907 refers to the step of cutting out the product 1 from the cellulose blank structure and thereby forming the residual cellulose fibre structure by removing the products from the cellulose blank structure,
According to one embodiment shown in FIG. 9 with a dotted arrow, the residual cellulose fibre structure in Box 907 is fed back to the Box 902 for providing BCC to the cellulose based material in Box 901 via the residual cellulose fibre structure.

According to what has been explained above according to an example embodiment, the residual cellulose fibre structure in Box 907 does not have to be fed back to Box 902, but can be rejected. However, for this example to be functional, BCC has to be adequately added, Box 902, to the cellulose-based material in Box 901 before the first mill 4 according to what has described above, e.g. what has been described in connection to FIG. 1.

Box 909 refers to the step of curing the product after forming.

It will be appreciated that the above description is merely exemplary in nature and is not intended to limit the present disclosure, its application or uses. While specific examples have been described in the specification and illustrated in the drawings, it will be understood by those of ordinary skill in the art that various changes may be made and equivalents may be substituted for elements thereof without departing from the scope of the present disclosure as defined in the claims. Furthermore, modifications may be made to adapt a particular situation or material to the teachings of the present disclosure without departing from the essential scope thereof. Therefore, it is intended that the present disclosure not be limited to the particular examples illustrated by the drawings and described in the specification as the best mode presently contemplated for carrying out the teachings of the present disclosure, but that the scope of the present disclosure will include any embodiments falling within the foregoing description and the appended claims. Reference signs mentioned in the claims should not be seen as limiting the extent of the matter protected by the claims, and their sole function is to make claims easier to understand.

### REFERENCE SIGNS

1: Cellulose product
2: Cellulose blank structure
2a: First surface, Cellulose blank structure
2b: Second surface, Cellulose blank structure
3: Barrier Chemistry Composition, BCC
4: First mill
4a: Forming hood
4b: Suction box
5: Forming mould
5a: First mould part
5b: Second mould part
6: Cellulose based material
6a: First tissue
6b: Second tissue
7a: First spray nozzle
8: Spray booth
9: Second mill
10: Residual cellulose fibre structure
11: Conveyer belt
11b: Carrying means
12: First calendaring apparatus
12b: Second calendaring apparatus
13: Control unit
14: Curing unit
15: Return buffer unit
16: Pressing unit
17: Sensor
18: Bypass conduit

1. A method for producing a cellulose product from an air-formed cellulose blank structure, wherein the method comprises the steps; providing a flow of cellulose based material to a first mill,
providing a flow of barrier chemistry composition (BCC), to the cellulose based material before the first mill and/or in the first mill and/or in a forming hood directly after the first mill,
defibrating the cellulose based material in the first mill into cellulose fibres, or defibrating the cellulose based material and the BCC in the first mill into cellulose fibres,
providing an air-formed cellulose blank structure partly comprising cellulose fibres with attached BCC and/or an air-formed cellulose blank structure partly comprising cellulose fibres with BCC in a dry form,
wherein the cellulose blank structure is air-formed from the cellulose fibres,
wherein the method comprises the step of arranging the cellulose blank structure in a forming mould and forming the cellulose product from the cellulose blank structure in the forming mould,
wherein the method comprises the step of controlling an amount of BCC to not exceed a predetermined maximum value in the product by controlling a ratio between the cellulose based material and the BCC before the first mill and/or in the forming hood.

2. The method according to claim 1, wherein the method comprises the step of providing a first tissue layer onto one side of the cellulose blank structure, wherein the first tissue layer comprises BCC.

3. The method according to claim 1, wherein the method comprises the step of providing a second tissue layer to one side of the cellulose blank structure, wherein the second tissue layer comprises BCC.

4. The method according to claim 2, wherein BCC is provided to the first and/or second tissue layer during production of the cellulose product and/or the step of providing BCC to the first and/or second tissue layer by providing BCC before production of the cellulose product.

5. The method according to claim 1, wherein the step of providing a flow of BCC comprises the step of providing BCC to the cellulose based material before production of the cellulose product and/or in production of the cellulose product.

6. The method according to claim 5, wherein the step of providing BCC to the cellulose based material before production of the cellulose product comprising the step of pre-treating the cellulose material partly with BCC forming a sectioned cellulose based material partly comprising BCC and/or where the step of providing BCC to the cellulose based material in production of the cellulose product comprises the step of providing BCC to selected parts of the cellulose material forming a sectioned base cellulose material partly comprising BCC.

7. The method according to claim 1, wherein the method comprises the step of providing BCC to the cellulose blank structure.

8. The method according to claim 1, wherein the method comprises a step of cutting out the cellulose product from the cellulose blank structure in and/or after a forming mould, thereby forming a residual cellulose fibre structure of the remaining cellulose blank structure comprising BCC, and
feeding the material of the residual cellulose fibre structure to the first mill and/or to the forming hood, as a complement to the flow of cellulose-based material.

9. The method according to claim 8, wherein the method comprises the step of providing BCC to the residual cellulose fibre structure.

10. The method according to claim 8, wherein the method comprises the step of adjusting the amount of applied (BCC) dependent on a material ratio based on an amount of the residual cellulose fibre structure and an amount of the cellulose-based material fed to the first mill and/or to the forming hood.

11. The method according to claim 10, wherein the step of adjusting the amount of the BCC is dynamically adjusted until the material ratio has reached a steady state during the production of the cellulose product.

12. The method according to claim 10, wherein the step of adjusting the amount of BCC is dynamically adjusted to ensure that an amount of BCC in the product is kept below the predetermined maximum value.

13. The method according to claim 8, wherein the step of feeding the material of residual cellulose fibre structure to the first mill comprises the step of milling the residual cellulose fibre structure in a second mill before feeding the material of the residual cellulose fibre structure to the first mill and/or to the forming hood.

14. The method according to claim 8, wherein the step of feeding the material of residual cellulose fibre structure to the first mill comprises feeding the residual cellulose fibre structure directly to the first mill without further defibration, or via a second calendaring apparatus to the first mill.

15. The method according to claim 1, wherein the method comprises the step of producing the product by arranging the cellulose blank structure with the BCC in a forming mould, and wherein the method comprises the step of heating the cellulose blank structure with the BCC to a forming temperature (TF) in the range of 100° C. to 300° C., and forming the cellulose product from the cellulose blank structure with the BCC in the forming mould, by pressing the heated cellulose blank structure with the BCC with a forming pressure (PF) of at least 1 MPa.

16. The method according to claim 15, wherein the step of producing the cellulose product from the cellulose blank structure comprises the step of curing the BCC based product in the heated forming mould.

17. The method according to claim 15, wherein the step of producing the cellulose product from the cellulose blank structure comprises the step of curing the BCC based product in a suitable thermal processing device after the step of cutting.

18. A cellulose product manufactured with a method according to claim 1, wherein the product comprises a barrier chemistry composition (BCC) embedded in a core of the product.

19. The cellulose product according to claim 18, wherein the product comprises a surface layer on at least a first side comprising formed tissue with an amount of BCC exceeding the amount of BCC in the core.

20-23. (canceled)

24. The method according to claim 15, wherein the forming pressure (PF) is 4-20 MPa.
